(19) United States
(12) Patent Application Publication
(10) Pub. No.: US 2025/0270846 A1
(43) Pub. Date: Aug. 28, 2025

(54) UWB separated antenna device

(71) Applicant: XTHINGS INDUSTRY LLC, Fremont, CA (US)

(72) Inventor: Lingling Qian, Fremont, CA (US)

(73) Assignee: XTHINGS INDUSTRY LLC, Fremont, CA (US)

(21) Appl. No.: 19/201,908

(22) Filed: May 7, 2025

(51) Int. Cl. E05B 9/08

(52) U.S. Cl. CPC E05B 9/08

(57) ABSTRACT

A UWB separated antenna device, wherein a rear hanging plate is fixed on a door panel; mounting holes are provided on the rear hanging plate symmetrically; a plurality of screws locked to corresponding screw holes of a front lock body are provided in the mounting holes; an oblique groove is provided on one side of the mounting holes; the oblique groove passes through the cable connected to the UWB antenna; and the UWB antenna is arranged in the antenna slot in a lower half portion of the rear lock body.

### TECHNICAL FIELD

The present invention relates to the technical field of smart locks, and in particular to a UWB (Ultra-Wideband) separated antenna device.

### BACKGROUND TECHNOLOGY

In the field of smart door locks, wireless communication is one of basic functions. Hardware basis of this technology is that wireless communication and sensing devices are respectively set on the front and rear lock bodies of the existing smart door locks, and these devices utilize a combination of existing terminals and wireless technologies to adapt to and meet people's needs for smart door locks' communication, unlocking and locking functions, as well as users' operating habits.

In the prior art, when a Wifi (wireless fidelity), Bluetooth or other radio frequency chip is to be set in a front lock body, it is necessary to connect through a radio frequency connector, that is, male and female connector terminals in the front and rear lock bodies are reserved and docked during an installation of the front and rear lock bodies respectively, and it is necessary to ensure that the connection is accurate and stable, otherwise it will affect normal and stable use of radio frequency signals. During the installation, since the rear lock body has been installed, it is difficult and complicated to operate an interconnection of the radio frequency terminals in a small space, which brings potential installation problems.

Based on the above reasons, the present invention designs a UWB (Ultra-Wideband) separated antenna device, wherein the UWB antenna is separated and directly set in the reserved position of the rear lock body, thereby avoiding the need for connection of radio frequency terminals in traditional processes, greatly improving convenience of installation and ensuring stability of signal communication.

### SUMMARY OF INVENTION

The purpose of the present invention is to overcome the shortcomings of the prior art and provide a UWB separated antenna device, wherein the UWB antenna is separated and directly set in a reserved position of a rear lock body, thereby avoiding the need for connection of radio frequency terminals in traditional processes, greatly improving convenience of installation and ensuring stability of signal communication.

In order to achieve the object above, the present invention provides a UWB separated antenna device, comprising a rear lock body, a rear hanging plate, a UWB antenna, a cable, a plurality of screws and an antenna slot, wherein the rear hanging plate is fixed on a door panel; mounting holes are provided on the rear hanging plate symmetrically; the plurality of screws locked to corresponding screw holes of a front lock body are provided in the mounting holes; an oblique groove is provided on one side of the mounting holes; the oblique groove passes through the cable connected to the UWB antenna; and the UWB antenna is arranged in the antenna slot in a lower half portion of the rear lock body.

A size of the rear hanging plate is consistent with a size of the lower half portion of the rear lock body.

The plurality of screws are tightly pressed with the door panel.

The UWB antenna is of an integrally packaged rectangular structure.

A size of a cross-sectional area of the UWB antenna is smaller than a size of an opening of the oblique groove; and in this way, it is possible for the UWB antenna to extend across the oblique groove.

The cable is connected with communication parts in the front lock body.

Compared with the prior art, the present invention packages the UWB antenna as a whole, and connects UWB antenna to components in the front lock body that need to communicate through a cable. At the same time, installation and fixing order of the front and rear lock bodies of the smart lock are taken into consideration, and the size of the UWB antenna is controlled to be easy to pass through the rear hanging plate that plays a fixing role, and can be directly placed in the antenna slot in the rear lock body; in this way, the traditional connection method of the antenna that requires the radio frequency terminals is improved. The antenna signal can be directly connected to sensing and detection components in the front lock body through a complete cable, thereby ensuring the convenient installation of the smart lock and the stability of communication.

### DESCRIPTION OF DRAWINGS

FIG. 1 is a schematic diagram of a rear hanging plate of the present invention.

FIG. 2 is a schematic diagram of after the rear hanging plate and a rear lock body of the present invention are assembled.

FIG. 3 is a schematic diagram of the rear lock body of the present invention.

FIG. 4 is an another schematic diagram after the rear hanging plate and the rear lock body of the present invention are assembled.

### EXPLANATION OF REFERENCE NUMERALS

1: rear lock body, 2: rear hanging plate, 3: UWB antenna, 4: cable, 5: screw, and 6: antenna slot.

### EMBODIMENTS

The invention will now be further described with reference to the attached drawings.

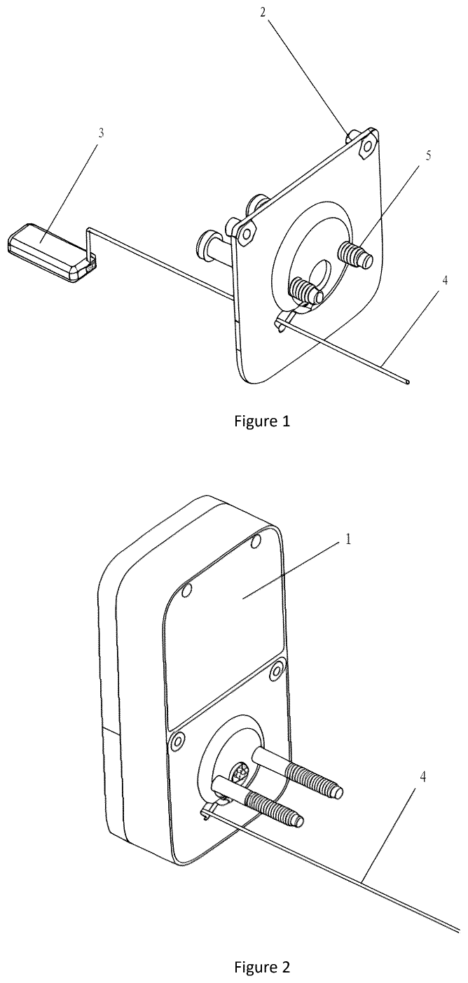

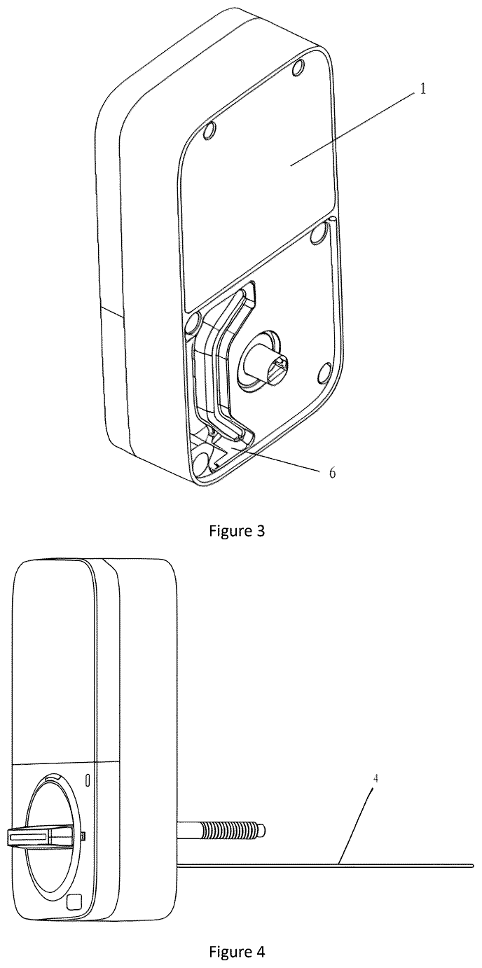

Referring to FIGS. 1 to 4, the present invention provides a UWB separated antenna device, comprising a rear lock body 1, a rear hanging plate 2, a UWB antenna 3, a cable 4, a plurality of screws 5 and an antenna slot 6, wherein the rear hanging plate 2 is fixed on a door panel; mounting holes are provided on the rear hanging plate 2 symmetrically; the plurality of screws 5 locked to corresponding screw holes of a front lock body are provided in the mounting holes; an oblique groove is provided on one side of the mounting holes; the oblique groove passes through the cable 4 connected to the UWB antenna 3; and the UWB antenna 3 is arranged in the antenna slot 6 in a lower half portion of the rear lock body 1.

A size of the rear hanging plate 2 is consistent with a size of the lower half portion of the rear lock body 1.

The plurality of screws 5 are tightly pressed with the door panel.

The UWB antenna 3 is of an integrally packaged rectangular structure.

A size of a cross-sectional area of the UWB antenna 3 is smaller than a size of an opening of the oblique groove; and in this way, it is possible for the UWB antenna 3 to extend across the oblique groove.

The cable 4 is connected with communication parts in the front lock body.

The above are only preferred embodiments of the present invention, which are only used to help understand the method and core ideas of the present application. The protective scope of the present invention is not limited to the above embodiments. All technical solutions under the concept of the present invention belong to the protective scope of the present invention. It should be pointed out that for ordinary technicians in this technical field, some improvements and modifications without departing from the principle of the present invention should also be regarded as the protective scope of the present invention.

The invention overall solves the shortcomings in the prior art that traditional communication equipment needs to use male and female radio frequency terminals for connection, resulting in unstable communication and high installation difficulty. The antenna is designed as a packaged whole and placed in the rear lock body, and is directly connected to the internal components of the front lock body only through a cable. Complexity and difficulty of the operation during the connection process with the radio frequency terminals are avoided, and installation space of the rear lock body is fully utilized to achieve miniaturized installation.

1. A UWB separated antenna device, comprising a rear lock body (1), a rear hanging plate (2), a UWB antenna (3), a cable (4), a plurality of screws (5) and an antenna slot (6), wherein the rear hanging plate (2) is fixed on a door panel; mounting holes are provided on the rear hanging plate (2) symmetrically; the plurality of screws (5) locked to corresponding screw holes of a front lock body are provided in the mounting holes; an oblique groove is provided on one side of the mounting holes; the oblique groove passes through the cable (4) connected to the UWB antenna (3); and the UWB antenna (3) is arranged in the antenna slot (6) in a lower half portion of the rear lock body (1).

2. The UWB separated antenna device according to claim 1, wherein a size of the rear hanging plate (2) is consistent with a size of the lower half portion of the rear lock body (1).

3. The UWB separated antenna device according to claim 1, wherein the plurality of screws (5) are tightly pressed with the door panel.

4. The UWB separated antenna device according to claim 1, wherein the UWB antenna (3) is of an integrally packaged rectangular structure.

5. The UWB separated antenna device according to claim 1, wherein a size of a cross-sectional area of the UWB antenna (3) is smaller than a size of an opening of the oblique groove; and in this way, it is possible for the UWB antenna (3) to extend from the oblique groove.

6. The UWB separated antenna device according to claim 1, wherein the cable (4) is connected with communication parts in the front lock body.
